(19) United States
(12) Patent Application Publication
(10) Pub. No.: US 2007/0090743 A1
(43) Pub. Date: Apr. 26, 2007

(54) Low-pressure mercury vapor discharge lamp with dummy seal

(75) Inventors: Piet Van Bendegem, Roosendaal (NL); Petrus Ephrem Caspar Gerardus Van Hoek, Eindhoven (NL); Pieter Cornelis Ooms, Roosendaal (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/559,216

(22) PCT Filed: May 28, 2004
(86) PCT No.: PCT/IB04/50801

§ 371 Date: Dec. 6, 2005

(30) Foreign Application Priority Data
Jun. 10, 2003 (EP) 03101683.5

(51) Int. Cl. H01J 5/48; H01J 63/04

(52) U.S. Cl. 313/318.02; 313/318.01; 313/484

(57) ABSTRACT

Low-pressure, mercury vapor discharge lamp has at least two dual-shaped lamp parts (1; 2; 3), each comprising a first and a second tube (11,21,31; 12;22;32). The first and second tube are interconnected via tube interconnection means (10; 20; 30) at a first end portion (11a, 12a;21a, 22a;31a,32a). A discharge path is formed through the tubes between two electrodes (13; 33). Each electrode is provided at a second end portion (11b; 32b) of one of the tubes (11; 32). Further second end portions (12b; 21b; 22b; 31b)are provided with respective sealed ends (12c; 21c; 22c; 31c). Bridge parts (50; 60) for interconnecting tubes (12,21; 22,31) of mutually adjacent dual-shaped lamp parts (1,2; 2,3) are provided in the proximity of the second end portions (12b,21b; 22b,31b). At least one of the sealed ends (21c) is provided with an exhaust tube (71) which is directly provided on the respective sealed end.

The invention relates to a low-pressure mercury vapor discharge lamp. In particular, the invention relates to a compact fluorescent lamp.

In mercury vapor discharge lamps, mercury constitutes the primary component for the (efficient) generation of ultraviolet (UV) light. A luminescent layer comprising a luminescent material may be present on an inner wall of the discharge vessel to convert UV to other wavelengths, for example to UV-B and UV-A for tanning purposes (sun panel lamps) or to visible radiation for general illumination purposes. Such discharge lamps are therefore also referred to as fluorescent lamps. Alternatively, the ultraviolet light generated may be used for manufacturing germicidal lamps (UV-C). The discharge vessel of a low-pressure mercury vapor discharge lamp is usually circular and comprises both elongate and compact embodiments. Generally, the tubular discharge vessel of compact fluorescent lamps comprises a collection of relatively short straight parts having a relatively small diameter, which straight parts are connected together by means of bridge parts or via bent parts. Compact fluorescent lamps are usually provided with an (integrated) lamp cap. Generally, the means for maintaining a discharge in the discharge space are electrodes arranged in the discharge space. There is a tendency in compact fluorescent lamps to shorten the height for promoting retrofitting normal incandescent lamps with compact fluorescent lamps.

GB-A 2 335 538 discloses a method of manufacturing a low-pressure mercury vapor discharge lamp. In this method four dual-shaped tubes, which were previously manufactured, are held at a distance in such a manner that the dual-shaped tubes can move in a horizontal plans. Four portions for connection are simultaneously heated, and two of the dual-shaped tubes are simultaneously moved horizontally to form bridge portions resulting in tube assemblies. Furthermore, annealing after bridge connection and connecting the tube assemblies to a bridge are simultaneously performed actions. The known compact fluorescent lamp comprises eight glass tubes that are connected to bridges so as to form a continuous discharge path.

A drawback of the known low-pressure mercury vapor discharge lamp is that the discharge path is still relatively short.

The invention has for its object to eliminate the above disadvantage wholly or partly. According to the invention, a low-pressure mercury vapor discharge lamp of the kind mentioned in the opening paragraph for this purpose comprises:

at least two dual-shaped lamp parts, each comprising a first tube and a second tube,

the first tube and the second tube being interconnected via a tube interconnection means at a first end portion of each tube,

a discharge path being formed through the tubes between two electrodes, each electrode being provided at a second end portion of one of the tubes, the second end portions facing away from the first end portions, the electrodes being provided at extreme ends of the discharge lamp,

further second end portions of the tubes being each provided with a sealed end,

bridge parts for interconnecting tubes of mutually adjacent dual-shaped lamp parts being provided in the proximity of the second end portions of the tubes,

at least one of the sealed ends being provided with an exhaust tube for evacuation and gas supply during manufacture of the discharge lamp,

the exhaust tube being directly provided on the sealed end.

In the known low-pressure mercury vapor discharge lamp, a stem provided with an electrode is inserted at extreme ends of the discharge lamp, thereby forming a discharge path through the tubes. In addition, a stem is also provided at the sealed ends which do not carry an electrode. Such a so-called dummy stem is provided with an exhaust tube for evacuation and gas supply during the manufacture of the discharge lamp. The presence of these dummy stems which project into the tubes of the discharge lamp, however, reduces the length of the discharge path through the discharge lamp. By providing, according to the invention, the exhaust tube directly on the sealed end, a stem can be avoided, and bridge parts for mutually connecting tubes of adjacent dual-shaped lamp parts can be provided closer to the further second end portions of the tubes. Since the bridge parts are closer to the end portions, the distance between the tube interconnection means and the bridge parts in the low-pressure mercury vapor discharge lamp according to the invention is longer, and the length of the discharge path is increased.

According to the measure of the invention, a low-pressure mercury vapor discharge lamp is obtained with an increased length of the discharge path, enabling the manufacture of a low-pressure mercury vapor discharge lamp with a smaller height but with the same optical characteristics as the known discharge lamp.

According to the invention, the bridge parts for interconnecting tubes of mutually adjacent dual-shaped lamp parts can be provided closer to the further second end portions of the tubes. To this end, a preferred embodiment of the low-pressure mercury vapor discharge lamp according to the invention is characterized in that the bridge part provided in the proximity of the sealed end with the exhaust tube is located at a distance d₁ from said sealed end, wherein d₁≦10 mm.

Preferably, the distance between the bridge part and the sealed end of the discharge lamp d₁≦7.5 mm. A very compact low-pressure mercury vapor discharge lamp can be realized because the length of the discharge path is considerably increased, enabling the manufacture of a low-pressure mercury vapor discharge lamp with a smaller height but with the same optical characteristics as the known discharge lamp.

A preferred embodiment of the low-pressure mercury vapor discharge lamp according to the invention is characterized in that the exhaust tube is fused to the sealed portion. The exhaust tube and the sealed end are heated during the manufacture of the low-pressure mercury vapor discharge lamp, whereby a direct connection is established between the exhaust tube and the sealed end.

A preferred embodiment of the low-pressure mercury vapor discharge lamp according to the invention is characterized in that each of the dual-shaped lamp parts is either provided with an electrode or with an exhaust tube. The electrode is preferably provided in the form of a stem-like construction. The exhaust tubes are provided directly on the sealed ends of the tubes.

In general, there are two embodiments of the low-pressure mercury vapor discharge lamp. The tube interconnection means comprises a so-called bridge portion in one embodiment of the low-pressure mercury vapor discharge lamp. In another embodiment of the low-pressure mercury vapor discharge lamp, the tube interconnection means comprises a bent portion.

These and other aspects of the invention are apparent from and will be elucidated with reference to the embodiments described hereinafter.

In the drawings:

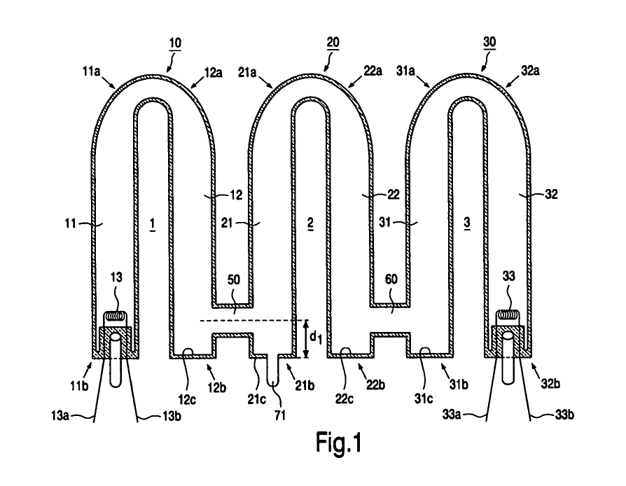

FIG. 1 is a cross-sectional view of an embodiment of the low-pressure mercury-vapor discharge lamp in accordance with the invention;

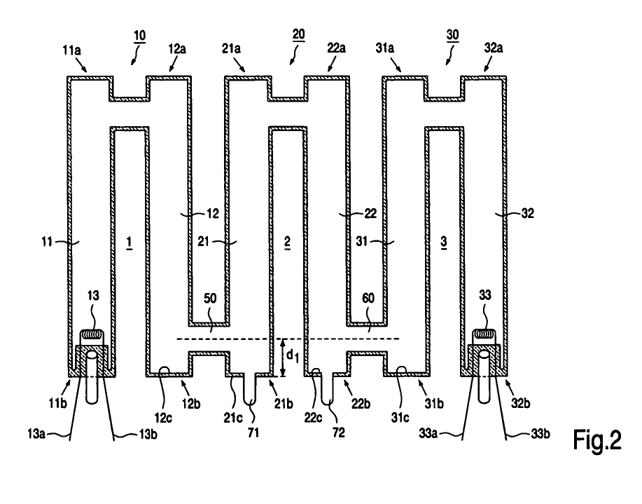

FIG. 2 shows an alternative embodiment of the low-pressure mercury vapor discharge lamp as shown in FIG. 1; and

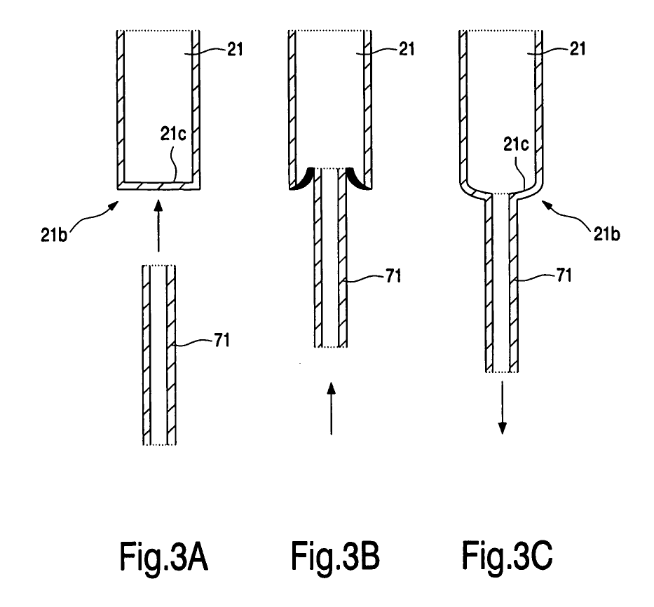

FIGS. 3A, 3B and 3C show steps in the manufacture of the discharge lamp according to the invention.

The Figures are purely diagrammatic and not drawn to scale. Notably, some dimensions are shown in a strongly exaggerated form for the sake of clarity. Similar components in the Figures are denoted as much as possible by the same reference numerals.

FIG. 1 schematically shows a low-pressure mercury-vapor discharge lamp comprising at least two dual-shaped lamp parts 1; 2; 3. Each of the dual-shaped lamp parts 1; 2; 3 comprises a first tube 11; 21; 31 and a second tube 12; 22; 32. The first tube 11; 21; 31 and the second tube 12; 22; 32 are interconnected via a tube interconnection means 10; 20; 30 at a first end portion 11a, 12a; 21a, 22a; 31a, 32a of each tube 11, 12; 21, 22; 31, 32. In the example of FIG. 1, the tube interconnection means 10; 20; 30 comprise so-called bent portions. FIG. 2 schematically shows an alternative embodiment of the low-pressure mercury vapor discharge lamp shown in FIG. 1. In the embodiment shown in FIG. 2, the tube interconnection means 10; 20; 30 comprise so-called bridge portions.

A discharge path is formed through the tubes 11, 12, 21, 22, 31, 32 between two electrodes 13; 33 in the low-pressure mercury vapor discharge lamps as shown in FIG. 1 and 2. Each of the electrodes 13, 33 is provided at a second end portion 11b; 32b of one of the tubes 11; 32, such that the second end portions 11b; 32b face away from the first end portions 11a; 31b. To obtain a long electrode path, the electrodes 13; 33 are provided at extreme ends of the discharge lamp.

In the example of FIGS. 1 and 2, the electrodes 13; 33 are supported by the end portions 11b; 32b. Normally, the electrode 13; 33 is a winding of tungsten covered with an electron-emitting substance, in this case a mixture of barium oxide, calcium oxide and strontium oxide. Current-supply conductors 13a, 13b; 33a, 33b of the respective electrodes 13; 33 pass through the end portions 11b; 32b and issue from the discharge lamp to the exterior. The current-supply conductors 13a, 13b; 33a, 33b may be provided with an amalgam (not shown in FIG. 1) for proportioning the mercury vapor pressure in the discharge lamp.

The dual-shaped lamp parts 1; 2; 3 formed by the tubes 11, 12, 21, 22, 31, 32 enclose, in a gastight manner, a discharge space containing a filling of mercury and an inert gas mixture comprising, for example, argon. The side of each tube 11, 12, 21, 22, 31, 32 facing the discharge space is preferably provided with a protective layer (not shown in FIG. 1). The side of each tube 11, 12, 21, 22, 31, 32 facing the discharge space is, in addition, coated with a luminescent layer (not shown in FIG. 1) which includes a luminescent material (for example a fluorescent powder) which converts the ultraviolet (UV) light generated by fallback of the excited mercury into (generally) visible light.

Apart from the second end portions 1b; 32b provided with electrodes 13; 33, further second end portions 12b; 21b; 22b; 31b of the tubes 12; 21; 22; 31 are provided with respective sealed ends 12c; 21c; 22c; 31c. Bridge parts 50; 60 for interconnecting tubes 12, 21; 22, 31 of mutually adjacent dual-shaped lamp parts with reference numerals 1, 2 and with reference numerals 2, 3 are provided in the proximity of said second end portions 12b, 21b; 22b; 31b of the tubes 12, 21; 22, 31. In addition, at least one of the sealed ends 21c; 22c is provided with an exhaust tube 71; 72 for evacuation and gas supply during manufacture of the discharge lamp. The exhaust tube 71; 72 is directly provided on the sealed end 21c; 22c.

In the example of FIG. 1, only one of the sealed ends 21c is provided with an exhaust tube 71, which is directly provided on the sealed end 21c. In the example of FIG. 2, two of the sealed ends 21c; 22c are provided with respective exhaust tubes 71; 72, which are also directly provided on the sealed end 21c; 22c.

A stem-like construction is employed for mounting the electrode 13; 33 in the low-pressure mercury vapor discharge lamp. According to the invention, a stem-like construction is avoided at the locations where the exhaust tubes 71; 72 are provided. In the known low-pressure mercury vapor discharge lamp, a stem is also provided at the sealed ends which do not carry an electrode. Such a so-called dummy stem is provided with an exhaust tube (“evacuation tube”) for evacuation and gas supply during the manufacture of the discharge lamp. The presence of these dummy stems projecting into the tubes of the discharge lamp, however, reduces the length of the discharge path through the discharge lamp. By providing, according to the invention, the exhaust tube 71; 72 directly on the sealed end 21c; 22c, a stem can be avoided. In addition, the bridge parts 50; 60 for interconnecting tubes 12, 21 and tubes 22, 31 of mutually adjacent dual-shaped lamp parts 1, 2 and 2, 3, respectively, can be provided closer to the further second end portions 21b; 22b of the tubes 21; 22. Since the bridge parts 50; 60 are closer to the second end portions 21b; 22b, the distance between the tube interconnection means 10; 20; 30 and the bridge parts 50; 60 in the low-pressure mercury vapor discharge lamp according to the invention is longer, and the length of the discharge path can be considerably increased.

If the manufacturer of discharge lamps according to the invention should decide to maintain the same optical characteristics (same light output) as with the known discharge lamp, he can reduce the dimensions of the discharge lamp; in particular, the manufacturer may reduce the height of the low-pressure mercury vapor discharge lamp.

In view of the measure of the invention, the bridge parts 50; 60 for interconnecting tubes 12, 21; 22, 31 of mutually adjacent dual-shaped lamp parts 1,2; 2, 3 can be provided much closer to the further second end portions 21b; 22b of the tubes 21; 22. Preferably, the distance d₁ between the bridge part 50; 60 provided in the proximity of the sealed end 21c; 22c with the exhaust tube 71; 72 is d₁≦10 mm. The distance d₁ is measured with respect to a longitudinal axis of the respective bridge part 50; 60 (see the dashed lines in FIGS. 1 and 2). In the known low-pressure mercury vapor discharge lamp, the distance d₁ between the bridge part and the sealed end of the discharge lamp, is well above 10 mm, normally even above 15 mm. Preferably, the distance d₁≦7.5 mm.

According to the invention, the exhaust tube 71; 72 is fused to the sealed portion 21c; 22c. FIGS. 3A, 3B and 3C schematically show steps in the manufacture of the discharge lamp according to the invention. In FIG. 3A, the exhaust tube 71 is brought in the proximity of the sealed end 21c of the second end portion 21b (see the arrow in FIG. 3A). Said second end portion 21b is heated, and the exhaust tube 71 is pressed into the weakened glass of the second end portion (see the arrow in FIG. 3B). The exhaust tube 71 contacts the sealed end 21c, and heat is transferred from the sealed end 21c to the exhaust tube 71. The rim of the exhaust tube 71 softens and fuses itself to the sealed end 21c at the second end portion 21b (schematically shown in FIG. 3B). As a next step, the exhaust tube 71 is pulled away from the sealed end 21c (see the arrow in FIG. 3C) until the sealed end portion 21cassumes the shape shown in FIG. 3C. Preferably, the amount of glass in the “shoulders” of the sealed end is reduced.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A low-pressure mercury vapor discharge lamp comprising:
at least two dual-shaped lamp parts (1; 2; 3), each comprising a first tube (11; 21; 31) and a second tube (12; 22; 32),
the first tube (11; 21; 31) and the second tube (12; 22; 32) being interconnected via a tube interconnection means (10; 20; 30) at a first end portion (11a, 12a; 21a, 22a; 31a, 32a) of each tube (11, 12; 21, 22; 31, 32),
a discharge path being formed through the tubes (11, 12, 21, 22, 31, 32) between two electrodes (13; 33), each electrode (13, 33) being provided at a second end portion (11b; 32b) of one of the tubes (11; 32), the second end portions (11b; 32b) facing away from the first end portions (11a; 31b), the electrodes (13; 33) being provided at extreme ends of the discharge lamp,
further second end portions (12b; 21b; 22b; 31b) of the tubes (12; 21; 22; 31) being each provided with a sealed end (12c; 21c; 22c; 31c),
bridge parts (50; 60) for interconnecting tubes (12, 21; 22, 31) of mutually adjacent dual-shaped lamp parts (1, 2; 2, 3) being provided in the proximity of the second end portions (12b, 21b; 22b, 31b) of the tubes (12, 21; 22, 31),
at least one of the sealed ends (21c; 22c) being provided with an exhaust tube (71; 72) for evacuation and gas supply during manufacture of the discharge lamp,
the exhaust tube (71; 72) being directly provided on the sealed end (21c; 22c).

2. A low-pressure mercury vapor discharge lamp as claimed in claim 1, characterized in that the bridge part (50) provided in the proximity of the sealed end (21c; 22c) with the exhaust tube (71; 72) is located at a distance d₁ from said sealed end (21c; 22c), wherein d₁≦10 mm.

3. A low-pressure mercury vapor discharge lamp as claimed in claim 2, characterized in that the distance d₁≦7.5 mm.

4. A low-pressure mercury vapor discharge lamp as claimed in claim 1, characterized in that the exhaust tube (71; 72) is fused to the sealed portion (21c; 22c).

5. A low-pressure mercury vapor discharge lamp as claimed in claim 1, characterized in that each of the dual-shaped lamp parts (1; 2; 3) is either provided with an electrode (13, 33) or with an exhaust tube (71; 72).

6. A low-pressure mercury vapor discharge lamp as claimed in claim 1, characterized in that the tube interconnection means (10; 20; 30) is either a bridge portion or a bent portion.
